(19) United States
(12) Patent Application Publication
(10) Pub. No.: US 2017/0176199 A1
(43) Pub. Date: Jun. 22, 2017

(54) SYSTEM AND METHOD TO FACILITATE DRIVING A VEHICLE BASED ON NAVIGATION INFORMATION AND A CONDITION OF A SOURCE OF ELECTRICAL POWER

(71) Applicant: JAGUAR LAND ROVER LIMITED, Warwickshire (GB)

(72) Inventor: Matt Jones, Portland, OR (US)

(21) Appl. No.: 14/972,433

(22) Filed: Dec. 17, 2015

(51) Int. Cl. G01C 21/34; G07C 5/02

(52) U.S. Cl. CPC G01C 21/3469; G07C 5/02; G01C 21/3492

(57) ABSTRACT

A system for use on a vehicle includes a user interface, such as a display and a speaker. A controller determines a remaining power capacity of a vehicle electrical power source and a required power capacity to travel along an identified route to an identified destination based on at least one characteristic of the identified route, which has an effect on electrical power use. The controller determines when a relationship between the remaining power capacity and the required power capacity satisfies at least one predetermined criterion. The system provides an indication of options based on at least one of the remaining power capacity, the determined relationship, or the predetermined criterion. The options may include an alternative route that consumes less power and an alternative destination where power is available for the electrical power source.

### TECHNICAL FIELD

The present disclosure relates to facilitating driving a vehicle based on navigation information and a condition, such as a remaining power capacity, of a vehicle electrical power source. Aspects of the invention relate to a system, a vehicle and a method.

### BACKGROUND

Modern vehicles are often equipped with electronics that provide information to a vehicle driver or owner. For example, many vehicles include a fuel gauge and an estimated driving range available based upon the remaining fuel in a fuel tank. For electric vehicles or hybrid electric vehicles, there may be an indication of an approximate possible travel distance based on a remaining charge of a source of electrical power for the vehicle. Some vehicle owners may feel comfortable with an understanding of how far they can travel based upon a range associated with remaining fuel for an internal combustion engine. The same is not necessarily true for electric vehicles or hybrid electric vehicles. Many drivers may feel uncertain regarding the capability of reaching an intended destination based upon the range information that may be available in some vehicles. Additionally, a simple indication of an estimated possible travel distance based on a remaining power capacity will not provide sufficient information for a variety of situations.

Embodiments of this invention provide enhanced and more accurate information to a driver regarding travel possibilities based upon a remaining power capacity of a vehicle electrical power source.

### SUMMARY

Aspects and embodiments of the invention provide a system, a method and a vehicle as claimed in the appended claims.

According to an aspect of the invention there is provided a method including determining a remaining power capacity of an electrical power source of a vehicle; determining a required power capacity for the vehicle to travel along an identified route to reach an identified destination based upon at least one characteristic of the identified route, the at least one characteristic having an effect on electrical power use; determining when a relationship between the remaining power capacity and the required power capacity satisfies at least one predetermined criterion; providing an indication of a plurality of options based on at least one of the remaining power capacity, the determined relationship, or the predetermined criterion, the plurality of options including, proceeding to the identified destination along an alternative route, and proceeding to an alternative destination where increasing the power capacity of the electrical power source is possible.

An example embodiment having one or more features of the method of the previous paragraph includes providing automated route guidance based on a user response to the plurality of options.

In an example embodiment having one or more features of the method of either of the previous paragraphs, the at least one predetermined criterion comprises at least one of the remaining power capacity being less than the required power capacity, the remaining power capacity being within a predetermined range of the required power capacity, and a difference between the remaining power capacity and the required power capacity being below a predetermined threshold.

In an example embodiment having one or more features of the method of any of the previous paragraphs, the at least one characteristic of the identified route comprises a distance along the identified route and at least one of: a change in elevation along at least a portion of the identified route, a traffic condition along at least a portion of the identified route, and a weather condition along at least a portion of the identified route.

In an example embodiment having one or more features of the method of any of the previous paragraphs, the at least one characteristic of the identified route comprises at least one of a change in elevation along at least a portion of the identified route, a traffic condition along at least a portion of the identified route, a weather condition along at least a portion of the identified route, and a remaining distance along the identified route.

In an example embodiment having one or more features of the method of any of the previous paragraphs, the alternative route has at least one alternative characteristic that has an effect on electrical power use, the at least one alternative characteristic resulting in less electrical power use and the at least one alternative characteristic comprises at least one of a change in elevation along at least a portion of the alternative route, a traffic condition along at least a portion of the alternative route, a weather condition along at least a portion of the identified route, and a distance along the alternative route.

An example embodiment having one or more features of the method of any of the previous paragraphs includes determining a location of at least one alternative destination where power is available to provide additional charge to the electrical power source of the vehicle, providing an indication regarding the determined location and providing automated route guidance to the determined location based on a user selection of the at least one alternative destination.

An example embodiment having one or more features of the method of any of the previous paragraphs includes identifying at least one vehicle system that utilizes electrical power and automatically altering operation of the at least one vehicle system in a manner that reduces an amount of electrical power utilized by the at least one vehicle system.

An example embodiment having one or more features of the method of any of the previous paragraphs includes identifying a plurality of vehicle systems that utilize electrical power and determining an order in which to automatically alter operation of at least two of the plurality of vehicle systems.

An example embodiment having one or more features of the method of any of the previous paragraphs includes identifying user a preference regarding an order in which operation of the plurality of vehicle systems should be automatically altered and selecting an order in which to automatically alter operation of at least two of the plurality of vehicle systems based on the identified user preference.

In an example embodiment having one or more features of the method of any of the previous paragraphs, a user can override the automatically altered operation and the method includes providing an indication regarding an expected impact on an ability to reach the identified destination resulting from the user overriding the automatically altered operation.

An example embodiment having one or more features of the method of any of the previous paragraphs includes continuing to provide automated route guidance along the identified route to the identified destination based on the user not selecting any of the provided options.

According to another aspect of the invention, there is provided a vehicle comprising a system configured to perform the method of any of the previous paragraphs.

According to another aspect of the invention, there is provided a system for use on a vehicle that includes user interface means for providing at least one of visual or audible information to a user; and control means for: determining a remaining power capacity of an electrical power source of a vehicle; determining a required power capacity for the vehicle to travel along an identified route to reach an identified destination based upon at least one characteristic of the identified route, the at least one characteristic having an effect on electrical power use; determining when a relationship between the remaining power capacity and the required power capacity satisfies at least one predetermined criterion; and providing an indication of a plurality of options through the user interface based on at least one of the remaining power capacity, the determined relationship, or the predetermined criterion, the plurality of options including, proceeding to the identified destination along an alternative route, and proceeding to an alternative destination where power is available to increase the power capacity of the electrical power source.

In an example embodiment having one or more features of the system of the previous paragraph, the control means and the user interface means are configured for providing automated route guidance through the user interface based on a user response to the plurality of options.

In an example embodiment having one or more features of the system of the previous paragraph, the control means comprises at least one power monitor processor device that is configured to determine the remaining power capacity and the required power capacity, at least one route guidance processor device that is configured to determine at least the alternative route, and at least one data storage device associated with the processors.

In an example embodiment having one or more features of the system of either of the previous paragraphs, the at least one predetermined criterion comprises at least one of the remaining power capacity being less than the required power capacity, the remaining power capacity being within a predetermined range of the required power capacity and a difference between the remaining power capacity and the required power capacity being below a predetermined threshold.

In an example embodiment having one or more features of the system of any of the previous paragraphs, the at least one characteristic of the identified route comprises a distance along the identified route and at least one of: a change in elevation along at least a portion of the identified route, a traffic condition along at least a portion of the identified route, and a weather condition along at least a portion of the identified route.

In an example embodiment having one or more features of the system of any of the previous paragraphs, the at least one characteristic of the identified route comprises at least one of a change in elevation along at least a portion of the identified route, a traffic condition along at least a portion of the identified route, a weather condition along at least a portion of the identified route, and a remaining distance along the identified route.

In an example embodiment having one or more features of the system of any of the previous paragraphs, the alternative route has at least one alternative characteristic that has an effect on electrical power use, the at least one alternative characteristic resulting in less electrical power use and the at least one alternative characteristic comprises at least one of a change in elevation along at least a portion of the alternative route, a traffic condition along at least a portion of the alternative route, a weather condition along at least a portion of the identified route, and a distance along the alternative route.

In an example embodiment having one or more features of the system of any of the previous paragraphs, the control means is configured for determining a location of at least one alternative destination where power is available to provide additional power capacity to the electrical power source of the vehicle, providing an indication regarding the determined location through the user interface and providing automated route guidance through the user interface to the determined location based on a user selection of the at least one alternative destination.

In an example embodiment having one or more features of the system of any of the previous paragraphs, the control means is configured for identifying at least one vehicle system that utilizes electrical power and automatically altering operation of the at least one vehicle system in a manner that reduces an amount of electrical power utilized by the at least one vehicle system.

In an example embodiment having one or more features of the system of any of the previous paragraphs, the control means is configured for identifying a plurality of vehicle systems that utilize electrical power and determining an order in which to automatically alter operation of at least two of the plurality of vehicle systems.

In an example embodiment having one or more features of the system of any of the previous paragraphs, the control means is configured for identifying user a preference regarding an order in which operation of the plurality of vehicle systems should be automatically altered and selecting an order in which to automatically alter operation of at least two of the plurality of vehicle systems based on the identified user preference.

In an example embodiment having one or more features of the system of any of the previous paragraphs, a user can override the automatically altered operation and the control means and the user interface means are configured for providing an indication regarding an expected impact on an ability to reach the identified destination resulting from the user overriding the automatically altered operation.

In an example embodiment having one or more features of the system of any of the previous paragraphs, the control means is configured for continuing to provide automated route guidance along the identified route to the identified destination through the user interface based on the user not selecting any of the provided options.

According to another aspect of the invention, there is provided a vehicle comprising the system of any of the previous paragraphs.

According to another aspect of the invention, there is provided a system for use on a vehicle that includes a user interface, which includes at least one of a display or a speaker to provide at least one of visual or audible information to a user. A controller is configured to: determine a remaining power capacity of an electrical power source of a vehicle; determine a required power capacity for the vehicle to travel along an identified route to reach an identified destination based upon at least one characteristic of the identified route, the at least one characteristic having an effect on electrical power use; determine when a relationship between the remaining power capacity and the required power capacity satisfies at least one predetermined criterion; provide an indication of a plurality of options through the user interface based on at least one of the remaining power capacity, the determined relationship, or the predetermined criterion, the plurality of options including, proceeding to the identified destination along an alternative route, and proceeding to an alternative destination where power is available to increase the power capacity of the electrical power source; and provide automated route guidance through the user interface based on a user response to the plurality of options.

Within the scope of this document it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 diagrammatically illustrates an example embodiment of a system designed according to an embodiment of this invention associated with a vehicle;

FIG. 2 diagrammatically illustrates selected portions of the example system situated in the interior of the example vehicle;

FIG. 3 schematically illustrates selected portions of a system designed according to an embodiment of this invention; and

FIG. 4 is a flow chart diagram that summarizes an example method of using navigation information while managing power capacity of a source of electrical power for a vehicle.

### DETAILED DESCRIPTION

Embodiments of this invention provide information to a driver regarding travel possibilities based upon a remaining power capacity of a source of electrical power for the vehicle.

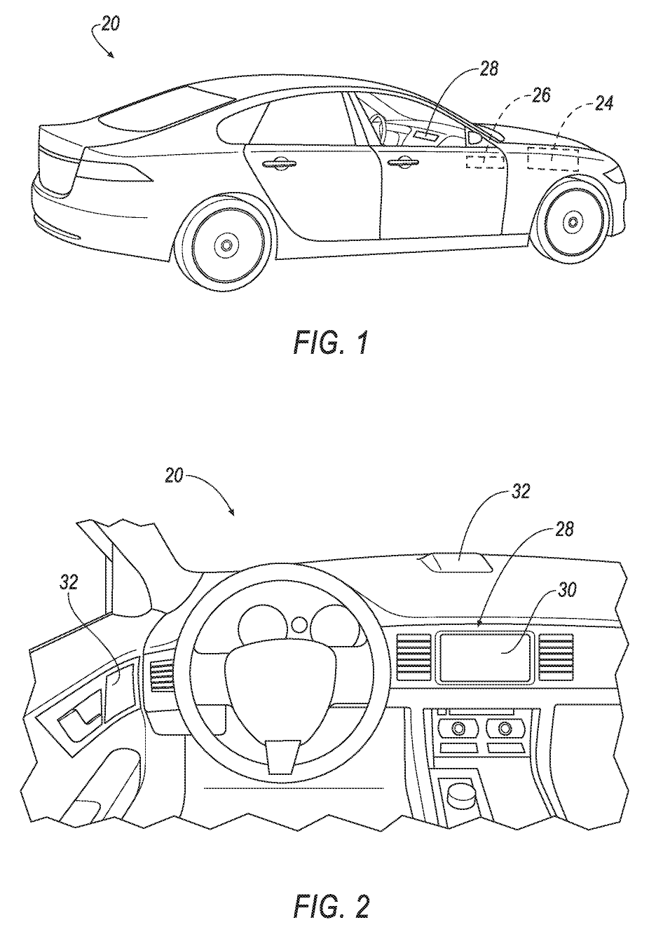

FIGS. 1-3 illustrate a vehicle 20 having an associated system 22 that facilitates driving the vehicle 20 based upon a power capacity of a source 24 of electrical power for the vehicle 20. The system 22 includes a control means 26 and a user interface means 28. In the illustrated example, the user interface means 28 includes a display screen 30 that provides visible information to an individual within the vehicle 20. The user interface means 28 in this example also includes at least one speaker 32 that provides audible information to an individual in the vehicle 20. The user interface means 28 is also capable of receiving information from an individual within the vehicle based on at least one input device, such as a microphone (not illustrated), a touch pad or control switch (not illustrated) or use of the display screen 30 when the embodiment includes a touch screen.

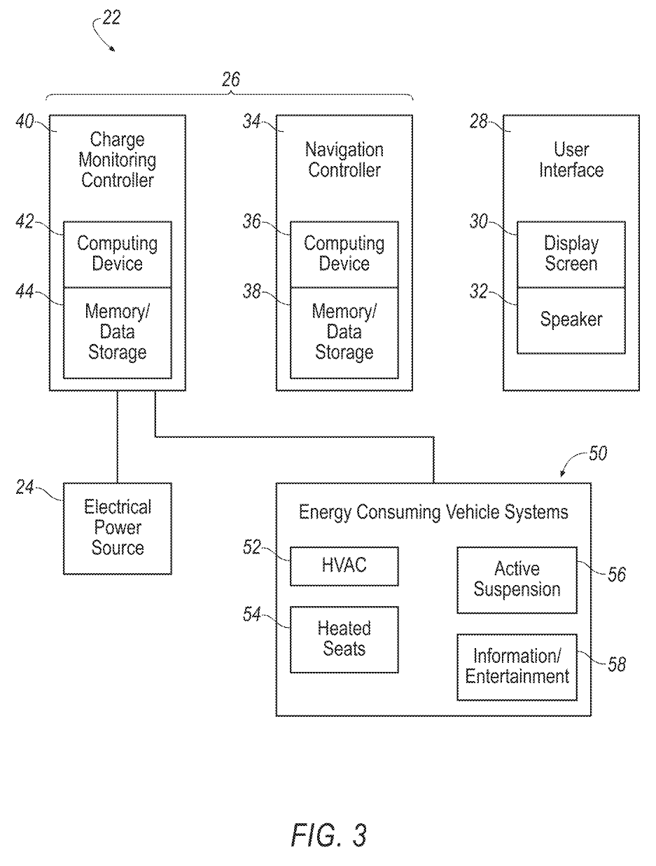

The control means 26 in this example includes at least one computing device or processor and associated data storage or memory. As shown in FIG. 3, the illustrated example includes a navigation controller 34 comprising a processor or computing device 36 and associated memory 38. The navigation controller 34 is programmed or otherwise configured to use known techniques for providing route guidance or navigation information to a driver of the vehicle 20.

The control means 26 in this example also includes a power monitor controller 40 that includes a computing device 42 and memory 44. The power monitor controller 40 is programmed or otherwise configured to make determinations regarding at least a current power capacity of the electrical power source 24, an amount of electrical power necessary for propelling the vehicle in various driving scenarios, and to utilize information from the navigation controller 34 for making such determinations.

Some embodiments will include discrete components for the navigation controller 34 and the power monitor controller 40, respectively, as schematically shown in FIG. 3. Other embodiments will include a single device as the controller that is configured to perform the different functions described as being performed by one of the respective controllers within this description. In a similar manner, some embodiments will have discrete devices used for the memory 38 and 44, respectively, while other embodiments will utilize a single memory. In some embodiments the memory 38 or 44 is maintained at a remote location and is accessible to the control means 26 using known data communication techniques. Given this description, those skilled in the art will realize what devices, hardware, software, firmware or combination of these will best meet the needs of their particular situation.

The power monitor controller 40 is configured to dynamically update information regarding a remaining power capacity or a remaining amount of power available from the electrical power source 24. Power capacity may be measured or quantified in different ways depending on the particular power source. For example, a battery capacity may be expressed in terms of charge while a fuel cell capacity may be expressed in terms of available reactants or fuel. For purposes of discussion in the remainder of this description, the electrical power source 24 is assumed to be a rechargeable device, such as a battery, but embodiments of this invention are not necessarily limited to any particular power source configuration. A variety of electrical power sources may be utilized to provide power necessary for propelling the vehicle 20.

As shown in FIG. 3, the power monitor controller 40 also utilizes information regarding a plurality of energy consuming vehicle systems schematically shown at 50. For discussion purposes and by way of example, energy consuming vehicle systems such as the heating, ventilation and air conditioning system (HVAC) 52, heated seats 54, active suspension 56, and information or entertainment system 58, utilize electrical power that may come from the electrical power source 24.

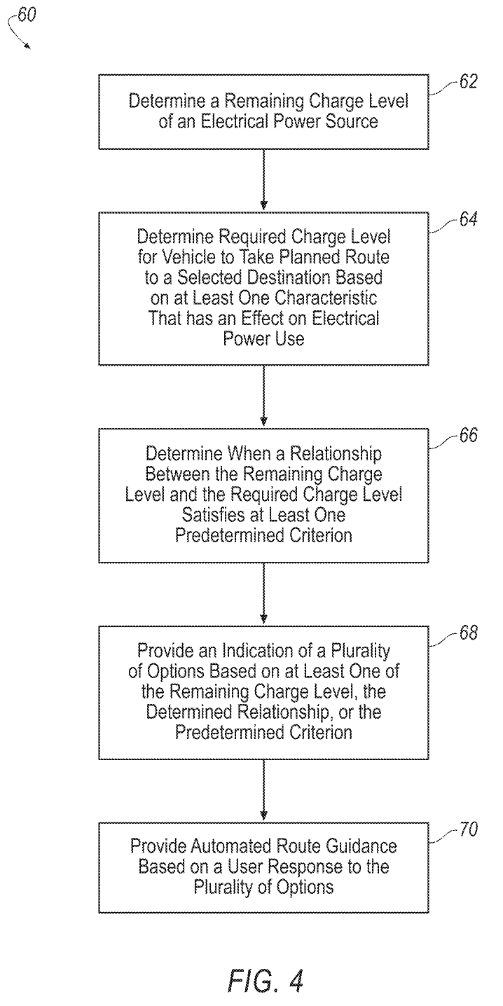

The control means 26 facilitates driving the vehicle based upon information regarding the remaining power capacity of the electrical power source 24 including providing information to a driver through the user interface means 28. FIG. 4 includes a flowchart diagram 60 that summarizes an example approach. At 62, the control means 26 determines a remaining charge level of the electrical power source 24. This can be accomplished in several known ways.

At 64, the control means 26 determines a required charge level for the vehicle 20 to follow an identified route to an identified destination. The route and destination may be identified in several ways. For example, the navigation controller 34 may have determined a recommended route based on user input regarding a desired destination. In that instance, the navigation controller 34 identifies the destination based on the user input and the identified route is a planned route based on the navigation controller 34 determining a route to the user's selected destination.

In some embodiments the control means 26 has the capability to identify a current route based on previously monitored route information that the control means has stored. The navigation controller 34 in such an embodiment monitors or tracks a route followed by the vehicle using known global positioning techniques to build a database of previous route information. In some cases a repeated route may be identified as a known route to a particular destination. For example, a driver may frequently travel the same route to a place of business at approximately the same time of day. The control means 26 uses information previously gathered by the navigation controller 34 regarding trips along such a route and recognizes that the same route is being followed to identify a current route and the expected destination even if the driver has not input a desired destination into the navigation system.

The route information may be stored in the memory 38 on an at least temporary basis at least for purposes of making the determinations explained in this description and for providing guidance to the driver along the route in a known manner.

In addition to the identified route and identified destination information, the navigation controller 34 has information regarding a current location of the vehicle 20, which can be determined in a known manner using global positioning system devices and techniques.

The determination at 64 is different than simply determining an estimated distance that could possibly be traveled by the vehicle 20. Instead, the determination at 64 is more specific and accurate because it takes into consideration at least one characteristic associated with the vehicle 20 traveling along the identified route to the identified destination. The characteristic that is considered at 64 has an effect on electrical power use.

There are a variety of characteristics that affect how a remaining charge level of the electrical power source 24 will be consumed as the vehicle follows the identified route. For example, when the identified route involves various or significant elevation or grade changes, that affects how much acceleration is required and how much regenerative braking may be available along the identified route. Elevation or grade information is known within many navigation databases or is available from a variety of sources through the Internet and can be obtained by the control means 26 in a known manner. Traffic conditions are another example characteristic that may have an effect on energy use while following the identified route. The total distance or remaining distance along an identified route also has an effect on the required charge level to reach the identified destination. Weather conditions may also affect energy usage along the identified route. For example, the ambient temperature impacts how much the driver will utilize the HVAC system 52. Additionally, information regarding the current operating conditions of the energy consuming vehicle systems 50 has an effect on the required charge level.

According to the illustrated embodiment, at least one such characteristic is taken into account when determining the required charge level at 64. Some example embodiments include always using the remaining distance along the identified route and at least one other factor as the at least one characteristic that affects energy consumption.

In some embodiments the control means 26 monitors energy usage while the vehicle 20 is driven along a monitored or identified route and stores such information in the memory 38 or 44, whether on board the vehicle or uploaded to a remote location. When such information is stored at a remote location it is possible for a service provider to gather such information from a variety of vehicles and to provide aggregated or averaged energy use information for various routes to a variety of vehicles having a system 22. In some embodiments the control means 26 accesses previous energy use information for at least a portion of the identified route and uses that information to determine the expected energy use on the current trip.

At 66, a determination is made by the control means 26 when a relationship between the remaining charge level and the required charge level satisfies at least one condition or criterion. There may be different relationships between the remaining charge level and the required charge level that are taken into account for different embodiments. One such relationship includes a difference between the remaining charge level and the required charge level. Whenever that difference falls within a predetermined range, or falls below a predetermined threshold, the predetermined criterion may be satisfied. Another example includes determining whenever the remaining charge level is less than the required charge level at 66.

At 68, the control means 26 controls or operates the user interface means 28 to provide an indication of a plurality of options to a driver. The options are determined based on at least one of (i) the remaining charge level of the power source 24, (ii) the relationship determined at 66 or (iii) the predetermined criterion used at 66. The options provided at 68 are intended to inform the driver regarding an expectation that the remaining charge level of the power source 24 may or will not be sufficient to reach the identified destination. The options presented at 68 in one example embodiment include allowing a driver to select a different destination (e.g., a stop-over or intermediate destination) that includes a source of power for charging the power source 24. For example, there may be known charge stations relatively near a current location of the vehicle 20, along the identified route, or accessible by taking a slight diversion from the identified route. Presenting information regarding the location of one or more such charge stations allows the vehicle driver to select one of them for purposes of recharging the power source 24 before attempting to reach the previously identified destination.

Some example embodiments include another option of selecting an alternative route to the identified destination. Given information, such as that described above, that affects how much power is consumed along a route, the control means 26 determines at least one alternative route to the identified destination that is expected to involve consuming less electrical power along the way. For example, an alternative route may include a longer distance but less change in elevation or different traffic conditions that are likely to result in less energy consumption.

In some embodiments, an option of ignoring the information pertaining to the remaining charge level is presented to the driver. This accommodates a situation in which a driver is confident that there is sufficient charge for reaching the identified destination along the currently identified route. Some embodiments do not require an explicit or specific input from the driver to indicate that the driver is ignoring the charge-related information, but instead relies upon expiration of a time period within which no input is received by the system after having provided the indications at 68.

At 70, the control means 26 utilizes the user interface means 28 to provide automated route guidance based upon the user response (or non-response) to the plurality of options that were presented at 68. For example, the navigation controller 34 provides updated or altered route guidance to a selected charge station location or the alternative route to the previously identified destination.

One feature of the illustrated example is that it has the capability of controlling operation of one or more of the energy consuming vehicle systems 50 in an automated manner that is intended to facilitate the driver reaching the selected or alternative destination. For example, under conditions in which the driver does not indicate any desire to deviate from the identified route to the identified destination, the power monitor controller 40 obtains information regarding the energy consuming vehicle systems 50 and determines which of those may be turned off or turned down in some manner to conserve electrical power. For example, the heated seats 54 may be turned off or a feature of the information or entertainment system 58 may be altered to reduce energy consumption (e.g., a display screen may be dimmed or turned off). Depending on a determination regarding outdoor temperature and the temperature of the interior of the vehicle 20, the HVAC system 52 may be controlled automatically to reduce an amount of energy consumption by that system.

One feature of the example control means 26 is that it allows for a driver or another individual in the vehicle to override any automatic adjustment or control over the energy consuming vehicle systems 50. The control means 26 in such an embodiment monitors such actions by a driver (or another individual) for purposes of learning a driver's preferences regarding which of the systems 50 may be automatically adjusted or an order in which those systems should be prioritized for adjustment when energy savings are desired. For example, a vehicle owner may not mind an information or entertainment display screen being turned off but may have a strong preference for a particular vehicle temperature. Under those conditions, the control means 26 will learn over time that adjusting the operation of such a display screen is preferred by the vehicle owner over making an adjustment to the HVAC system 52. Utilizing such information and controlling the systems 50 accordingly increases the satisfaction and reduces inconvenience to the vehicle owner while still obtaining energy savings when the available charge from the power source 24 is at a level that makes it at least somewhat questionable whether an intended destination is reachable.

Some example embodiments will provide an indication through the user interface means 28 regarding the automated control over the energy consuming systems 50 to alleviate any suspicion that the affected system is potentially malfunctioning. Additionally, some systems 22 will provide an indication to the driver that an override of the automated control is possible with a warning that such an override may result in insufficient power for the trip.

In the illustrated embodiment the control means 26 recognizes when the driver overrides any automated adjustment to the power consuming systems 50 and causes the user interface means 28 to provide an indication to the driver of the potential consequences of the override. For example, the display screen 30 may show a warning that the charge level will be insufficient to complete the trip if energy is not saved by allowing the automated control over the energy consuming system to continue.

The disclosed embodiments utilize information available from the navigation controller 34 to facilitate relying upon electrical power to propel a vehicle to a desired destination and managing energy consumption.

The preceding description is illustrative rather than limiting in nature. Variations and modifications to the disclosed examples may become apparent to those skilled in the art that do not necessarily depart from the essence of the contribution to the art provided by the disclosed embodiments. The scope of legal protection can only be determined by studying the following claims.

I claim:

1. A method comprising:
determining a remaining power capacity of an electrical power source of a vehicle;
determining a required power capacity for the vehicle to travel along an identified route to reach an identified destination based upon at least one characteristic of the identified route, the at least one characteristic having an effect on electrical power use;
determining when a relationship between the remaining power capacity and the required power capacity satisfies at least one predetermined criterion; and
providing an indication of a plurality of options based on at least one of the remaining power capacity, the determined relationship, or the predetermined criterion, the plurality of options including, proceeding to the identified destination along an alternative route, and proceeding to an alternative destination where power is available to charge the electrical power source.

2. The method of claim 1, comprising providing automated route guidance based on a user response to the plurality of options.

3. The method of claim 1, wherein the at least one predetermined criterion comprises at least one of
the remaining power capacity being less than the required power capacity,
the remaining power capacity being within a predetermined range of the required power capacity, and
a difference between the remaining power capacity and the required power capacity being below a predetermined threshold.

4. The method of claim 1, wherein the at least one characteristic of the identified route comprises a remaining distance along the identified route and at least one of
a change in elevation along at least a portion of the identified route,
a traffic condition along at least a portion of the identified route, and
a weather condition along at least a portion of the identified route.

5. The method of claim 1, wherein the at least one characteristic of the identified route comprises at least one of
a change in elevation along at least a portion of the identified route,
a traffic condition along at least a portion of the identified route,
a weather condition along at least a portion of the identified route, and
a remaining distance along the identified route.

6. The method of claim 5, wherein
the alternative route has at least one alternative characteristic that has an effect on electrical power use, the at least one alternative characteristic resulting in less electrical power use; and
the at least one alternative characteristic comprises at least one of
a change in elevation along at least a portion of the alternative route,
a traffic condition along at least a portion of the alternative route,
a weather condition along at least a portion of the alternative route, and
a distance along the alternative route.

7. The method of claim 1, comprising
determining a location of at least one alternative destination where power is available to provide additional charge to the electrical power source of the vehicle;
providing an indication regarding the determined location; and
providing automated route guidance to the determined location based on a user selection of the at least one alternative destination.

8. The method of claim 1, comprising
identifying at least one vehicle system that utilizes electrical power; and
automatically altering operation of the at least one vehicle system in a manner that reduces an amount of electrical power utilized by the at least one vehicle system.

9. The method of claim 8, comprising
identifying a plurality of vehicle systems that utilize electrical power; and
determining an order in which to automatically alter operation of at least two of the plurality of vehicle systems.

10. The method of claim 9, comprising
identifying user a preference regarding an order in which operation of the plurality of vehicle systems should be automatically altered; and
selecting an order in which to automatically alter operation of at least two of the plurality of vehicle systems based on the identified user preference.

11. The method of claim 8, wherein
a user can override the automatically altered operation; and
the method comprises
providing an indication regarding an expected impact on an ability to reach the identified destination resulting from the user overriding the automatically altered operation.

12. The method of claim 1, comprising providing automated route guidance along the identified route to the identified destination based on the user not selecting any of the provided options.

13. A vehicle comprising a navigation system configured to perform the method of claim 1.

14. A system for use on a vehicle, comprising:
user interface means for providing at least one of visual or audible information to a user; and
control means for
determining a remaining power capacity of an electrical power source of a vehicle;
determining a required power capacity for the vehicle to travel along an identified route to reach an identified destination based upon at least one characteristic of the identified route, the at least one characteristic having an effect on electrical power use;
determining when a relationship between the remaining power capacity and the required power capacity satisfies at least one predetermined criterion; and
providing an indication of a plurality of options through the user interface based on at least one of the remaining power capacity, the determined relationship, or the predetermined criterion, the plurality of options including, proceeding to the identified destination along an alternative route, and proceeding to an alternative destination where increasing the power capacity of the electrical power source is possible

15. The system of claim 14, wherein the control means and the user interface means are configured for providing automated route guidance through the user interface based on a user response to the plurality of options.

16. The system of claim 14, wherein the control means comprises
at least one power monitor processor device that is configured to determine the remaining power capacity and the required power capacity;
at least one route guidance processor device that is configured to determine at least the alternative route; and
at least data storage device associated with the processors.

17. The system of claim 14, wherein the at least one predetermined criterion comprises at least one of
the remaining power capacity being less than the required power capacity,
the remaining power capacity being within a predetermined range of the required power capacity, and
a difference between the remaining power capacity and the required power capacity being below a predetermined threshold.

18. The system of claim 14, wherein the at least one characteristic of the identified route comprises a remaining distance along the identified route at least one of
a change in elevation along at least a portion of the identified route,
a traffic condition along at least a portion of the identified route, and
a weather condition along at least a portion of the identified route.

19. The system of claim 14, wherein
the alternative route has at least one alternative characteristic that has an effect on electrical power use, the at least one alternative characteristic resulting in less electrical power use; and
the at least one alternative characteristic comprises at least one of
a change in elevation along at least a portion of the alternative route,
a traffic condition along at least a portion of the alternative route,
a weather condition along at least a portion of the alternative route, and
a distance along the alternative route.

20. The system of claim 14, wherein the control means is configured for
determining a location of at least one alternative destination where power is available to provide additional charge to the electrical power source of the vehicle;
providing an indication regarding the determined location through the user interface; and
providing automated route guidance through the user interface to the determined location based on a user selection of the at least one alternative destination.

21. The system of claim 14, wherein the control means is configured for
identifying at least one vehicle system that utilizes electrical power; and
automatically altering operation of the at least one vehicle system in a manner that reduces an amount of electrical power utilized by the at least one vehicle system.

22. The system of claim 21, wherein the control means is configured for
identifying a plurality of vehicle systems that utilize electrical power; and
determining an order in which to automatically alter operation of at least two of the plurality of vehicle systems.

23. The system of claim 22, wherein the control means is configured for
identifying user a preference regarding an order in which operation of the plurality of vehicle systems should be automatically altered; and
selecting an order in which to automatically alter operation of at least two of the plurality of vehicle systems based on the identified user preference.

24. The system of claim 21, wherein
a user can override the automatically altered operation; and
the control means and the user interface means are configured for providing an indication regarding an expected impact on an ability to reach the identified destination resulting from the user overriding the automatically altered operation.

25. The system of claim 14, wherein the control means is configured for continuing to provide automated route guidance along the identified route to the identified destination through the user interface based on the user not selecting any of the provided options.

26. A vehicle comprising the system of claim 14.
